(19) United States
(12) Patent Application Publication
(10) Pub. No.: US 2026/0155534 A1
(43) Pub. Date: Jun. 4, 2026

(54) ENERGY STORAGE DEVICE

(71) Applicant: TOYOTA JIDOSHA KABUSHIKI KAISHA, Toyota-shi (JP)

(72) Inventors: Kunihiro TSUNEKAWA, Toyota-shi (JP); Koki Nakada, Toyota-shi (JP); Shinya Takeshita, Toyota-shi (JP); Naoyuki Takahashi, Toyoake-shi (JP); Ryo Kimura, Nagoya-shi (JP); Kazuhito Kato, Toyota-shi (JP); Toshihiro Shimonaka, Toyota-shi (JP); Kota Ichisawa, Toyota-shi (JP); Kenta Miyahara, Toyohashi-shi (JP)

(73) Assignee: TOYOTA JIDOSHA KABUSHIKI KAISHA, Toyota-shi (JP)

(21) Appl. No.: 19/296,079

(22) Filed: Aug. 11, 2025

(30) Foreign Application Priority Data
Dec. 3, 2024 (JP) 2024-210169

(51) Int. Cl. H01M 50/503; H01M 50/242; H01M 50/271; H01M 50/325; H01M 50/358; H01M 50/514; H01M 50/519; H01M 50/55; H01M 50/557

(52) U.S. Cl. CPC H01M 50/503; H01M 50/242; H01M 50/271; H01M 50/325; H01M 50/358; H01M 50/514; H01M 50/519; H01M 50/55; H01M 50/557

(57) ABSTRACT

An energy storage device includes an energy storage cell including an electrode terminal, and a conductor member. The conductor member includes a housing portion and a through hole extending from a surface of the conductor member to the housing portion. The energy storage device further includes a receiving member disposed in the housing portion. The electrode terminal is connected to the receiving member through the through hole, and is electrically connected to the conductor member at a position outward of the first through hole in the housing portion.

### CROSS-REFERENCE TO RELATED APPLICATION

This application claims priority to Japanese Patent Application No. 2024-210169 filed on Dec. 3, 2024. The disclosure of the above-identified application, including the specification, drawings, and claims, is incorporated by reference herein in its entirety.

### BACKGROUND

### 1. Technical Field

The present disclosure relates to energy storage devices.

### 2. Description of Related Art

Chinese Unexamined Patent Application Publication No. 116686151 discloses an energy storage device including a plurality of energy storage cells fixed in a case (housing cavity). Electrode terminals of each energy storage cell are provided to face the bottom wall of the case.

### SUMMARY

In the energy storage device described in Chinese Unexamined Patent Application Publication No. 116686151, it is not necessarily easy to connect the energy storage cells and busbars (conductor members) and to maintain such connections.

The present disclosure has been made to address the above issue, and an object thereof is to facilitate connections between energy storage cells and conductor members and maintenance of such connections.

An aspect of the present disclosure provides an energy storage device. The energy storage device includes an energy storage cell including an electrode terminal, and a conductor member. The conductor member includes a housing portion and a through hole extending from a surface of the conductor member to the housing portion. The energy storage device further includes a receiving member disposed in the housing portion. The electrode terminal is connected to the receiving member through the through hole, and is electrically connected to the conductor member at a position outward of the first through hole in the housing portion.

The present disclosure facilitates connections between energy storage cells and conductor members and maintenance of such connections.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates an overview of an energy storage device according to an embodiment of the present disclosure;

FIG. 2 shows the interior of the energy storage device according to the embodiment;

FIG. 3 is an end view of the energy storage device taken along line III-III in FIG. 2;

FIG. 4 illustrates the connection structure between electrode terminals of the energy storage cell and a wiring board;

FIG. 5 illustrates a method for manufacturing the wiring board according to the embodiment; and

FIG. 6 shows a modification of the configuration shown in FIG. 4.

### DETAILED DESCRIPTION OF EMBODIMENTS

An embodiment of the present disclosure will be described in detail with reference to the drawings. The same or corresponding portions are denoted by the same signs throughout the drawings, and description thereof will not be repeated. In the drawings used in the following description, the X-axis, Y-axis, and Z-axis represent three axes that are perpendicular to each other. Hereinafter, a plus sign “+” is used to indicate the directions pointed by the arrows of the X-axis, Y-axis, and Z-axis, and a minus sign “−” is used to indicate the opposite directions.

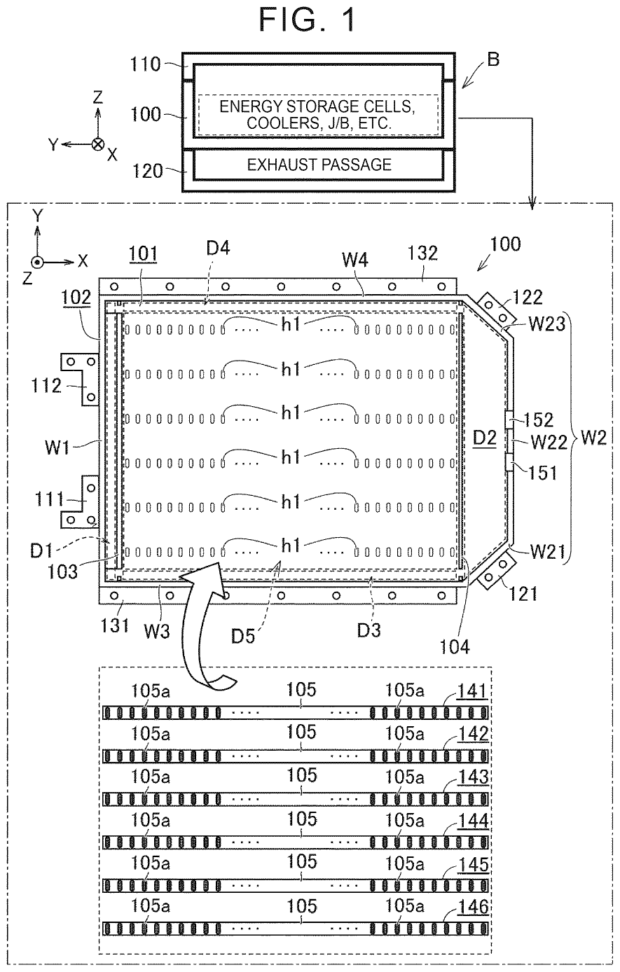

FIG. 1 illustrates an overview of an energy storage device according to the present embodiment.

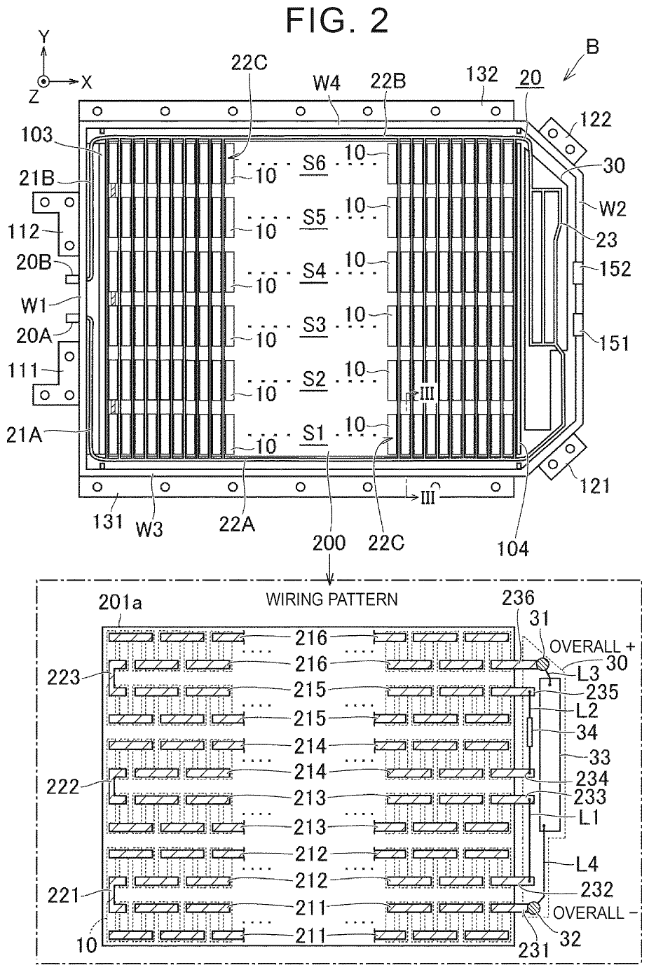

Referring to FIG. 1, an energy storage device B according to the present embodiment includes a lower case 100 (first housing member), an upper cover 110 (second housing member), and a shear panel 120 (third housing member), and these components serve as a housing for the energy storage device B. The lower case 100 is open upward (in the +Z-direction), and houses a plurality of energy storage cells and various components associated with the energy storage cells. As will be described in detail later, the lower case 100 houses the energy storage cells, a cooler, a junction box (hereinafter referred to as “J/B”), etc. (see FIG. 2). The upper cover 110 is disposed above the lower case 100 and serves as a lid for the lower case 100. The shear panel 120 is disposed below (on the −Z-side of) the lower case 100, and serves to reduce impacts on the lower case 100 caused by contact with the road surface. An exhaust passage is formed between the lower case 100 and the shear panel 120.

For example, in a state where the energy storage device B is mounted on a vehicle, the −Z-side is downward (downward in the vertical direction), the +Z-side is upward (upward in the vertical direction), the −X-side is the front side of the vehicle, and the +X-side is the rear side of the vehicle. The energy storage device B may serve as a traction energy storage device that is commonly referred to as “battery pack.” The vehicle may be a battery electric vehicle (BEV) or any other type of electrified vehicle (xEV).

The lower part of FIG. 1 shows the lower case 100 in an empty state (a state in which nothing is housed) as viewed from above (+Z-side). The lower case 100 includes a bottom wall 101 (bottom) and a peripheral wall 102 (peripheral portion). The bottom wall 101 includes regions D1 to D5. The peripheral wall 102 includes side walls W1 to W4. The side walls W1, W2, W3, W4 correspond to the −X-side, +X-side, −Y-side, and +Y-side ends of the lower case 100, respectively. The side wall W2 includes side walls W21 to W23. The side walls W21, W23 are provided with brackets 121, 122, respectively. The side wall W22 is provided with exhaust valves 151, 152. The side wall W22 is connected to the side walls W3, W4 via the side walls W21, W23, respectively. The side walls W3, W4 are provided with brackets 131, 132, respectively. The side wall W1 is provided with brackets 111, 112. The energy storage device B is connected to the body (e.g., a floor panel) of the vehicle by fastening the brackets to, for example, a floor member of the vehicle.

The bottom wall 101 is provided with partition walls 103, 104 extending in the Y-direction. The partition wall 104 is located on the +X-side relative to the partition wall 103. The region D5 is a rectangular region located in the central portion of the lower case 100 and is defined by the partition walls 103, 104. The region D5 is a region where a wiring board 200 and energy storage stacks S1 to S6 (see FIG. 2), which will be described later, are arranged. The region D5 is located between the partition walls 103, 104.

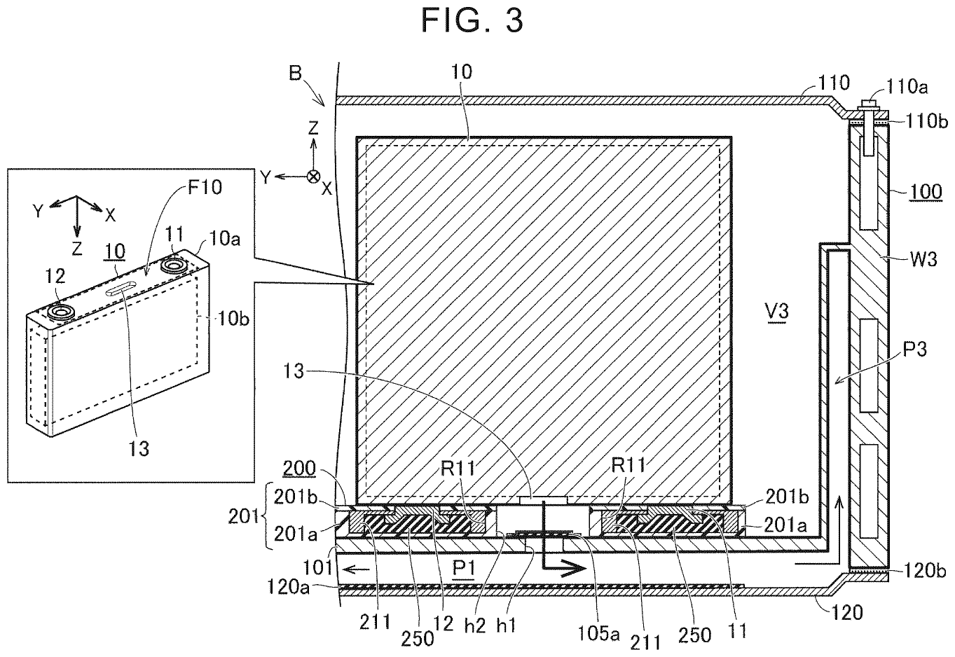

The region D5 has openings h1 at positions where the energy storage cells are disposed. Each of the openings h1 is disposed to face a valve 13 (see FIG. 3) of a corresponding one of energy storage cells 10, which will be described later, in the Z-direction. The openings h1 are arranged in the X-direction to form rows of the openings h1. The number of rows formed in the bottom wall 101 corresponds to the number of energy storage stacks. The openings h1 are, for example, elongated holes that extend through the bottom wall 101. However, the shape of the opening h1 can be changed as appropriate. The openings h1 are formed by, for example, punching.

In the present embodiment, cover members 141 to 146 are provided in the region D5 of the bottom wall 101. All of the openings h1 formed in the bottom wall 101 are thus covered by the cover members 141 to 146. Each of the cover members 141 to 146 includes a base member 105 that is elongated in the X-direction, and N lids 105a arranged in the X-direction. In the present embodiment, the number of energy storage cells included in one energy storage stack is also N. N is, for example, 20 or more and 50 or less. However, the present disclosure is not limited to this, and N may be 2 or more and less than 20, or may be more than 50.

The base member 105 may have an adhesive on its one surface (adhesive surface). The base member 105 may be, for example, an adhesive tape such as a polypropylene (PP) tape. The N lids 105a are formed on the base member 105. In the present embodiment, the lids 105a include mica. The N lids 105a of each of the cover members 141, 142, 143, 144, 145, 146 are formed to close the openings h1 located below a corresponding one of the energy storage stacks S1, S2, S3, S4, S5, S6 (see FIG. 2) that will be described later. The size of the lid 105a is the same as or greater than the size of the opening h1. For example, the N lids 105a may be formed on the base member 105 by attaching N pieces of mica foil to the adhesive surface of the base member 105. Alternatively, the N lids 105a may be formed on the base member 105 by forming N through holes in the base member 105 and providing mica foil in each of the through holes. Each of the cover members 141 to 146 is attached to the upper surface (+Z-side surface) of the bottom wall 101 via, for example, the adhesive surface of the base member 105.

The regions D3, D4 are provided on the −Y-side and +Y-side of the region D5, respectively. The region D1 is provided outward (on the −X-side) of the partition wall 103. The region D2 is provided outward (on the +X-side) of the partition wall 104. The region D2 is a region where a battery circuit unit 30 (FIG. 2) is disposed. The region D2 is located at the +X-side end of the lower case 100 and is defined by the partition wall 104 and the side wall W2. In the present embodiment, the bottom wall 101, the peripheral wall 102, and the partition walls 103, 104 are each made of metal. However, the material of these walls can be changed as appropriate.

FIG. 2 shows the interior of the lower case 100 (the interior of the energy storage device B) with the upper cover 110 removed, as viewed from above. Referring to FIG. 2, the energy storage stacks S1 to S6, a cooling device 20, the battery circuit unit 30, and the wiring board 200 are housed between the lower case 100 and the upper cover 110. Each of the energy storage stacks S1 to S6 includes N energy storage cells 10 arranged in the X-direction. The configuration of each energy storage cell will be described in detail later. The wiring board 200 has a wiring pattern for the energy storage stacks S1 to S6. The battery circuit unit 30 includes a circuit electrically connected to the energy storage stacks S1 to S6. The battery circuit unit 30 may be a single unit, or may include a plurality of units.

The cooling device 20 includes ports 20A, 20B, pipes 21A, 21B extending in the Y-direction, pipes 22A, 22B extending in the X-direction, a plurality of coolers 22C extending in the Y-direction, and a cooling pipe 23. These components are connected in the following order from the upstream side: port 20A, pipe 21A, pipe 22A, cooling pipe 23, pipe 22B, pipe 21B, and port 20B. The pipes 22A, 22B are connected to each other via the coolers 22C (cooling plates) arranged in the X-direction. A cooler 22C is disposed between each pair of adjacent energy storage cells in the energy storage stacks S1 to S6. The adjacent energy storage cells are cooled by a cooling medium flowing through a channel formed inside the cooler 22C. Each cooler 22C has a channel communicating with each of the pipes 22A, 22B. The cooling pipe 23 is configured to cool the battery circuit unit 30.

Referring to FIGS. 1 and 2, the ports 20A, 20B are provided inn the side wall W1. The port 20B is located on the +Y-side relative to the port 20A. The pipes 21A, 21B are disposed in the region D1. The pipes 22A, 22B are disposed in the regions D3, D4, respectively. The cooling pipe 23 is disposed in the region D2. The coolers 22C are disposed in the region D5. The cooling medium supplied from the port 20A to the pipe 21A flows through the pipe 21A in the −Y-direction. The cooling medium that has entered the pipe 22A from the pipe 21A flows through the pipe 22A in the +X-direction toward the cooling pipe 23, and also flows into the channels in the coolers 22C. The cooling medium that has entered the coolers 22C from the pipe 22A flows in the +Y-direction toward the pipe 22B while cooling the energy storage stacks S1 to S6. The cooling medium that has entered the cooling pipe 23 from the pipe 22A flows in the +Y-direction toward the pipe 22B while cooling the battery circuit unit 30. The cooling medium that has entered the pipe 22B from the coolers 22C or the cooling pipe 23 flows through the pipe 22B in the −X-direction toward the pipe 21B. The cooling medium then flows through the pipe 21B in the −Y-direction and flows out from the port 20B. The cooling medium may be a liquid (such as water, oil, or antifreeze fluid) or a gas.

In the present embodiment, the wiring board 200 is disposed on the +Z-side of the bottom wall 101, and the energy storage stacks S1 to S6 are disposed on the +Z-side of the wiring board 200.

FIG. 3 is an end view of the energy storage device B taken along line III-III in FIG. 2. As shown in the perspective view on the left side of FIG. 3, the energy storage cell 10 includes a case 10a and an electrode assembly 10b housed in the case 10a. The case 10a is a rectangular parallelepiped case. The electrode assembly 10b may include one or more windings (e.g., two windings). The winding has a structure in which, for example, a cathode sheet and an anode sheet are wound with a separator interposed therebetween. Each of the cathode sheet and the anode sheet includes an electrode foil and an active material layer. The energy storage cell 10 is a secondary cell such as a lithium-ion cell, a nickel metal hydride cell, or a sodium-ion cell. In the present embodiment, a liquid lithium-ion cell is used as the energy storage cell 10. The case 10a contains an electrolyte solution together with the electrode assembly 10b. The secondary cell may be of any type, and may be, for example, an all-solid-state secondary cell. A stack (e.g., a stack in which a cathode sheet and an anode sheet are stacked with a separator interposed therebetween) may be used instead of the winding.

The energy storage cell 10 has electrode terminals 11, 12 and the valve 13 on the same surface. Specifically, the electrode terminals 11, 12 and the valve 13 are provided on a surface F10 (a surface facing downward in the vertical direction) of the case 10a. The valve 13 serves as an exhaust valve. The case 10a is basically maintained in a sealed state. However, when the pressure inside the case 10a exceeds a first reference value, the valve 13 opens to reduce the pressure inside the case 10a. The electrode terminal 11 and the electrode terminal 12 are respectively electrically connected to the cathode sheet and the anode sheet of the electrode assembly 10b, and respectively serve as a cathode terminal and an anode terminal. The portions of the case 10a that surround the electrode terminals 11, 12 may be made of an insulating material, and the other portions of the case 10a may be made of metal. However, the present disclosure is not limited to this, and the case 10a may be made of any material.

In the present embodiment, the energy storage cells included in the energy storage stacks S1 to S6 have the same configuration (the configuration shown in FIG. 3). Forming the energy storage stacks S1 to S6 using the same type of energy storage cells 10 facilitates the manufacturing of the energy storage device B and reduces the manufacturing cost. However, the present disclosure is not limited to this, and each energy storage stack may include a plurality of types of energy storage cells. The number of energy storage stacks can be changed as appropriate. The number of energy storage stacks may be one, or may be two more.

The energy storage cells included in the energy storage stacks S1 to S6 are electrically connected by the wiring pattern of the wiring board 200. An example of the wiring pattern is shown in the lower part of FIG. 2.

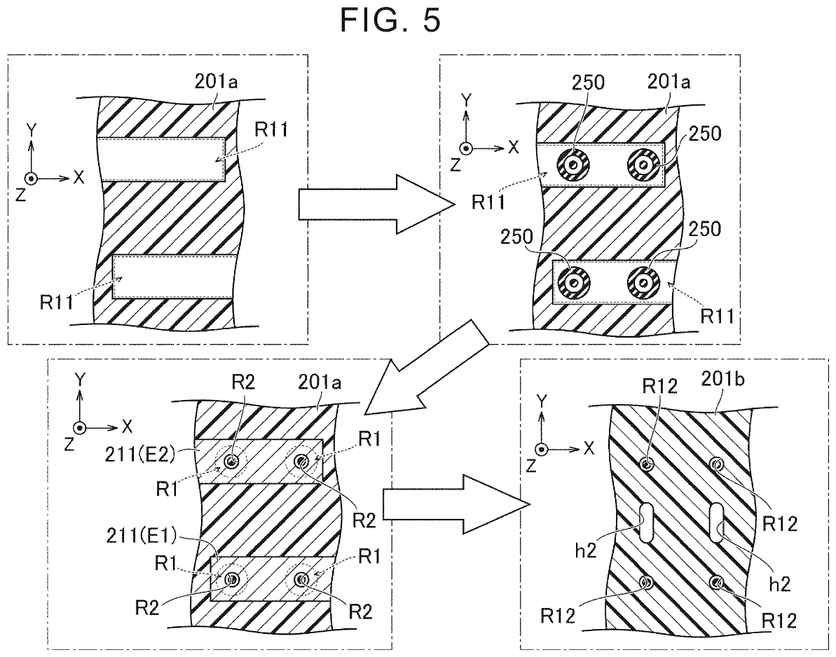

Specifically, the wiring board 200 includes an insulating substrate 201a, a plurality of conductor members 211, a plurality of conductor members 212, a plurality of conductor members 213, a plurality of conductor members 214, a plurality of conductor members 215, a plurality of conductor members 216, conductor members 221 to 223, and conductor members 231 to 236. The insulating substrate 201a is made of, for example, resin. Although not shown in FIG. 2, the wiring board 200 further includes an insulating sheet 201b, and the insulating substrate 201a (first insulating layer) and the insulating sheet 201b (second insulating layer) have a plurality of openings h2 (through holes). The structure of the wiring board 200 will be described in detail later (see FIGS. 3 and 5).

Each of the conductor members 211 electrically connects the energy storage cells included in the energy storage stack S1. Each of the conductor members 212 electrically connects the energy storage cells included in the energy storage stack S2. Each of the conductor members 213 electrically connects the energy storage cells included in the energy storage stack S3. Each of the conductor members 214 electrically connects the energy storage cells included in the energy storage stack S4. Each of the conductor members 215 electrically connects the energy storage cells included in the energy storage stack S5. Each of the conductor members 216 electrically connects the energy storage cells included in the energy storage stack S6.

The conductor member 221 electrically connects the energy storage stacks S1, S2. The conductor member 222 electrically connects the energy storage stacks S3, S4. The conductor member 223 electrically connects the energy storage stacks S5, S6. The conductor members 231, 232, 233, 234, 235, 236 electrically connect the energy storage stacks S1, S2, S3, S4, S5, S6 to the battery circuit unit 30, respectively.

In the present embodiment, the wiring pattern is formed by the conductor members described above. Each of the conductor members 211 to 216, 221 to 223, 231 to 236 is, for example, a plate-shaped member made of metal. Each of the conductor members 221 to 223 may be a plate-shaped member having a U-shape. Each conductor member may be a busbar. Each conductor member may be made of any material and may have any shape.

The wiring board 200 is electrically connected to the battery circuit unit 30. The battery circuit unit 30 includes an overall positive terminal 31, an overall negative terminal 32, a J/B 33, a fuse 34, and electrical wires L1 to L4. The overall positive terminal 31 is located at the cathode-side end of the entire energy storage device B (all the energy storage cells). The overall negative terminal 32 is located at the anode-side end of the entire energy storage device B. The electrical wire L1 electrically connects the conductor member 232 and the conductor member 233. The electrical wire L2 electrically connects the conductor member 234 and the conductor member 235. The fuse 34 is provided on the electrical wire L2. The conductor member 236 is connected to the overall positive terminal 31. The electrical wire L3 electrically connects the overall positive terminal 31 and the J/B 33. The conductor member 231 is connected to the overall negative terminal 32. The electrical wire L4 electrically connects the overall negative terminal 32 and the J/B 33. The J/B 33 houses various electrical devices. The J/B 33 may include at least one of a relay, a fuse, a resistive element, a current sensor, and a connector (e.g., a connector to an in-vehicle charger). The battery circuit unit 30 may further include either or both of a battery management system (BMS) and an electronic control unit (ECU).

The partition wall 104 may have openings for passing the conductor members 231 to 236 therethrough. Alternatively, an electrical wire (e.g., a cable) connected to the wiring board 200 may be passed above the partition wall 104 and connected to the battery circuit unit 30. The partition walls 103, 104 may not be provided. Either or both of the partition walls 103, 104 may be omitted.

The energy storage stacks S1 to S6 include a total of “6×N” energy storage cells 10 arranged in a matrix with six rows in the Y-direction and N columns in the X-direction. In the wiring pattern shown in FIG. 2, a plurality of parallel-connected units is connected in series. The N energy storage cells 10 are disposed such that the positional relationship between the electrode terminal 11 (cathode terminal) and the electrode terminal 12 (anode terminal) is reversed every two energy storage cells 10. Each of the conductor members 211 to 216 connects every two energy storage cells of the corresponding energy storage stack in parallel and connects the resulting parallel-connected units (the energy storage cells connected in parallel) in series. How the energy storage cells are connected can be changed as appropriate. For example, the number of energy storage cells connected in parallel may be three or more, instead of two. All the energy storage cells may be connected in series instead of forming the parallel-connected units.

The wiring board 200 has a substrate 201 shown in FIG. 3. The substrate 201 includes the insulating substrate 201a and the insulating sheet 201b. The insulating substrate 201a has a plurality of recesses R11. A conductor member 211 and a receiving member 250 that are connected to the electrode terminal 11 of the energy storage cell 10 are disposed in one recess R11. A conductor member 211 and a receiving member 250 that are connected to the electrode terminal 12 of the energy storage cell 10 are disposed in another recess R11. The insulating sheet 201b is disposed on the +Z-side of the insulating substrate 201a, and covers the +Z-side surfaces of the conductive members disposed in the recesses R11. Each of the electrode terminals 11, 12 shown in FIG. 3 extends through the insulating sheet 201b and the corresponding conductive member 211 and is connected to the corresponding receiving member 250. The distal end of each of the electrode terminals 11, 12 is plastically deformed inside the substrate 201 in accordance with the surface shape of the receiving member 250, and is electrically connected to the corresponding conductor member 211 (for example, by crimping).

The substrate 201 has the openings h2 shown in FIG. 3 at the same positions in an X-Y plane as the openings h1 (FIG. 1). Each of the openings h2 that are equal in number to the openings h1 (6×N) faces the valve 13 of a corresponding one of the energy storage cells 10 in the Z-direction. The openings h2 are, for example, elongated holes that extend through the substrate 201. The openings h2 have a larger dimension in the X-Y plane than the openings h1. In the X-Y plane, each of the openings h1 is located inside a corresponding one of the openings h2. As shown in FIG. 3, each of the openings h2 is connected to a corresponding one of the openings h1 via a corresponding one of the lids 105a.

In the manufacturing of the energy storage device B, for example, after the wiring board 200 is installed in the lower case 100, the energy storage stacks S1 to S6 are mounted on the wiring board 200 with the surfaces F10 of the energy storage cells facing downward in the vertical direction. The battery circuit unit 30 is then connected to the wiring board 200, and the cooling device 20 is installed in the lower case 100. As a result, the interior of the lower case 100 is in the state shown in FIG. 2. The coolers 22C of the cooling device 20 may be installed in the lower case 100 together with the energy storage stacks S1 to S6. Thereafter, the remaining parts of the cooling device 20 may be placed in the lower case 100, and each of the pipes 22A, 22B may be connected to the coolers 22C. Each of the wiring board 200 and the battery circuit unit 30 may be fixed to the lower case 100 by an adhesive (e.g., a silicone adhesive).

As shown in FIG. 3, the upper cover 110 is joined to the upper surfaces (+Z-side surfaces) of the side walls W1 to W4 (only the side wall W3 is shown in FIG. 3) via, for example, an adhesive 110b, and is further fastened by bolts 110a. The shear panel 120 is joined to the lower surfaces (−Z-side surfaces) of the side walls W1 to W4 via, for example, an adhesive 120b. Although not shown in FIG. 3, the pipe 22A shown in FIG. 2 is disposed in a space V3 between the side wall W3 and the energy storage cells 10 located at the −Y-side end in the lower case 100.

An exhaust passage P1 is formed between the bottom wall 101 of the lower case 100 and the shear panel 120. The side walls W1 to W4 are hollow. An exhaust passage P3 is formed inside the side wall W3. Although not shown in the figures, an exhaust passage is also formed inside each of the side walls W2, W4 in a manner similar to that of the exhaust passage P3 of the side wall W3. These exhaust passages communicate with each other. The side wall W2 has exhaust holes connected to the exhaust valves 151, 152 (FIG. 2). These exhaust holes communicate with the exhaust passage.

When the pressure inside the energy storage cell 10 exceeds a first reference value, the valve 13 opens as shown in FIG. 3. As a result, a hole is formed in the lid 105a facing the valve 13 due to the pressure and heat of gas discharged from inside the energy storage cell 10 through the valve 13. The gas discharged from the energy storage cell 10 passes through the hole and flows into the exhaust passage P1. Each of the exhaust valves 151, 152 shown in FIG. 2 opens when the pressure in the exhaust passage exceeds a second reference value. The second reference value may be a pressure value lower than the first reference value. The exhaust valves 151, 152 are, for example, check valves. When either or both of the exhaust valves 151, 152 open, gas in each exhaust passage flows toward the open exhaust valve(s) and is discharged to the outside of the energy storage device B through that exhaust valve(s). The thickness of each lid 105a provided on the lower case 100 (FIG. 1) is set to a thickness small enough that a hole is formed when the valve 13 facing the lid 105a opens (e.g., when the valve opens in a manner that causes ignition).

A mica layer 120a (e.g., mica foil) is provided on the inner (+Z-side) surface of the shear panel 120. The mica layer 120a may be provided to overlap all of the lids 105a in the X-Y plane. The mica layer 120a protects the shear panel 120 from substances (gas, electrolyte solution, debris, etc.) discharged from the energy storage cells 10 through the lids 105a.

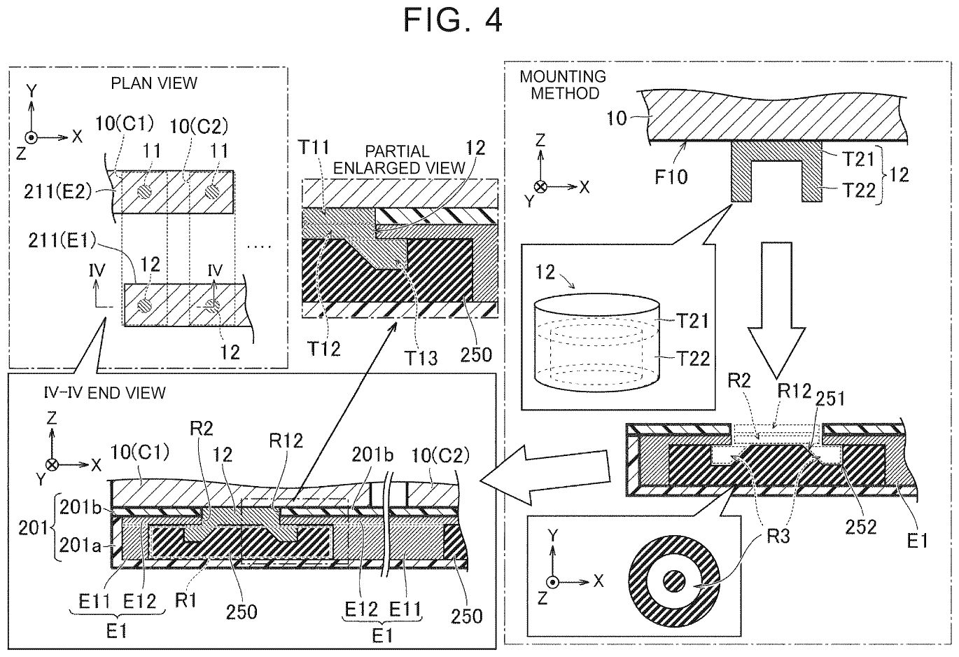

FIG. 4 illustrates the connection structure between the electrode terminals of the energy storage cell 10 and the conductor member of the wiring board 200. FIG. 4 shows the structure of one conductor member (conductor member 211) as a representative example. However, in the present embodiment, the other conductor members included in the wiring board 200 also have the structure shown in FIG. 4. In the plan view at the upper left of FIG. 4, two conductor members 211 of the wiring pattern shown in FIG. 2 are shown in an enlarged form. Hereinafter, of these two conductor members 211, the conductor member 211 on the −Y-side will also be referred to as “conductor member E1,” and the conductor member 211 on the +Y-side will also be referred to as “conductor member E2.” The electrode terminals 12 of two energy storage cells 10 arranged side by side in the X-direction are connected to the conductor member E1. Of these two energy storage cells 10, the energy storage cell 10 on the −X-side will also be referred to as to as “energy storage cell C1,” and the energy storage cell 10 on the +X-side will also be referred to as “energy storage cell C2.” The electrode terminals 11 of the energy storage cells C1, C2 are connected to the conductor member E2.

As shown in the IV-IV end view (the end view taken along line IV-IV in the plan view), the conductor member E1 has a housing portion R1 and a through hole R2. The through hole R2 extends from the surface (+Z-side surface) of the conductor member E1 to the housing portion R1. The housing portion R1 expands outward (in a direction away from the center of the electrode terminal) from the through hole R2. In the X-Y plane, the through hole R2 is located inside the housing portion R1. The receiving member 250 that receives the distal end of the electrode terminal of the energy storage cell 10 is disposed in the housing portion R1. The conductor member E1 includes a first layer E11 (first conductor layer) located to the side (in the X- or Y-direction) of the receiving member 250, and a second layer E12 (second conductor layer) connected to the +Z-side end face of the first layer E11. The through hole R2 is formed in the second layer E12. The first layer E11 and the second layer E12 may be separately formed and then joined together, or may be integrally formed in a seamless manner. Through holes R12 are formed in the insulating sheet 201b disposed on the +Z-side of the conductor member E1 at positions corresponding to the through holes R2. The through hole R2 (first through hole) and the through hole R12 (second through hole) may be formed to have the same shape and the same dimensions in the X-Y plane. In the present embodiment, the wiring board 200 is manufactured such that the wiring pattern (including the conductor member E1) shown in FIG. 2 and the receiving members 250 are disposed inside the substrate 201.

FIG. 5 illustrates a method for manufacturing the wiring board 200. Referring to FIG. 5, the insulating substrate 201a is first prepared. Next, a recess R11 is formed in each of the regions of the insulating substrate 201a that correspond to the wiring pattern.

Thereafter, in each recess R11, a receiving member 250 is provided at the location where the electrode terminal of the energy storage cell 10 is to be disposed. Each of the receiving members 250 may be fixed to the insulating substrate 201a with an adhesive.

Subsequently, each of the conductor members (including the conductor members E1, E2) corresponding to the wiring pattern is provided in a corresponding one of the recesses R11. Each of the conductor members has the housing portion R1 and the through hole R2 that are described above. A receiving member 250 is accommodated in the housing portion R1 of each conductor member. The through hole R2 is positioned on the +Z-side of the receiving member 250.

Subsequently, an insulating sheet 201b is provided on the +Z-side of the insulating substrate 201a and each conductive member. The insulating sheet 201b may be a resin sheet (e.g., a resin film). The substrate 201 is thus formed by the insulating substrate 201a and the insulating sheet 201b. The insulating substrate 201a and each conductive member are covered by the insulating sheet 201b. The insulating sheet 201b has through holes R12 at positions corresponding to the through holes R2. From above the substrate 201, the receiving members 250 disposed inside the substrate 201 are visible through the through holes R2, R12. Thereafter, a plurality of openings h2 extending through the substrate 201 is formed. Each of the openings h2 is formed at a position facing the valve 13 of a corresponding one of the energy storage cells 10 by, for example, punching. The wiring board 200 is thus completed.

The method for manufacturing the wiring board 200 is not limited to the above method. For example, after the first layer E11 is formed in the recess R11, the receiving member 250 may be provided, and the second layer E12 may then be formed over the first layer E11 and the receiving member 250. The first layer E11 and the second layer E12 may subsequently be joined together.

Referring again to FIG. 4, in the present embodiment, each electrode terminal of the energy storage cell 10 is connected to the receiving member 250 through the through hole R2 of a corresponding one of the conductor members, and is also electrically connected to the conductor member at a position outward of the through hole R2 in the housing portion R1. Specifically, as shown in the partial enlarged view in FIG. 4, each electrode terminal of the energy storage cell 10 (electrode terminal 12 is illustrated in FIG. 4) includes a first portion T11 extending from the body (case 10a) of the energy storage cell 10 to the through hole R2, a second portion T12 located within the through hole R2, and a third portion T13 extending from the through hole R2 to the receiving member 250. The third portion T13 contacts the surface of the receiving member 250 in the housing portion R1 and is plastically deformed outward on the surface of the receiving member 250.

A method for mounting the energy storage cell 10 is shown on the right side of FIG. 4. The receiving member 250 has an opening R3 formed in a ring shape in the X-Y plane. More specifically, the surface of the receiving member 250 includes an inclined surface 251 that slopes downward toward the outside, and a step 252 located outward of the inclined surface 251. The step 252 is formed by a bottom surface connected to the outer end of the inclined surface 251 and a wall surface that stands in the +Z-direction from the bottom surface. The opening R3 is defined by the inclined surface 251 and the bottom and wall surfaces of the step 252. The opening R3 is connected to the through hole R2. In the X-Y plane, at least part of the inclined surface 251 is positioned inside the through holes R2, R12. The receiving member 250 is made of an insulating material (e.g., resin). However, the present disclosure is not limited to this, and the receiving member 250 may be made of a metal (e.g., aluminum).

Before the energy storage cell 10 is mounted, each electrode terminal (electrode terminal 12 is illustrated in FIG. 4) includes a disc-shaped proximal end T21 connected to the body (surface F10) of the energy storage cell 10, and a tubular distal end T22 protruding in the −Z-direction from the proximal end T21. During the mounting of the energy storage cell 10, the tubular distal end T22 is inserted into the ring-shaped opening R3, and a force is applied to the energy storage cell 10 in the −Z-direction. The distal end T22 is pressed against the inclined surface 251 and is thus plastically deformed. As a result, the structure shown in the IV-IV end view in FIG. 4 is formed. The distal end T22 pressed against the inclined surface 251 receives an outward force in accordance with the shape of the inclined surface 251. As the distal end T22 is plastically deformed outward and comes into contact with the step 252, the distal end T22 is further plastically deformed in the +Z-direction (toward the second layer E12). As a result, a third portion T13 having a ring shape is formed in the ring-shaped opening R3. In the present embodiment, the third portion T13 is in contact with the rear surface (−Z-side surface) of the second layer E12. The surface F10 of the energy storage cell 10 is in contact with the insulating sheet 201b.

As described above, according to the configuration shown in FIG. 4, the electrode terminals of the energy storage cell 10 can be electrically connected to the wiring pattern (one of the conductor members of the wiring board 200) by bringing the distal end of each electrode terminal of the energy storage cell 10 into contact with the receiving member 250 and thus plastically deforming the distal end of each electrode terminal. This facilitates mounting of the energy storage cells 10 onto the wiring board 200 (e.g., the joining of the electrode terminals to busbars), and facilitates connections between the energy storage cells 10 and the conductor members and maintenance of the connections.

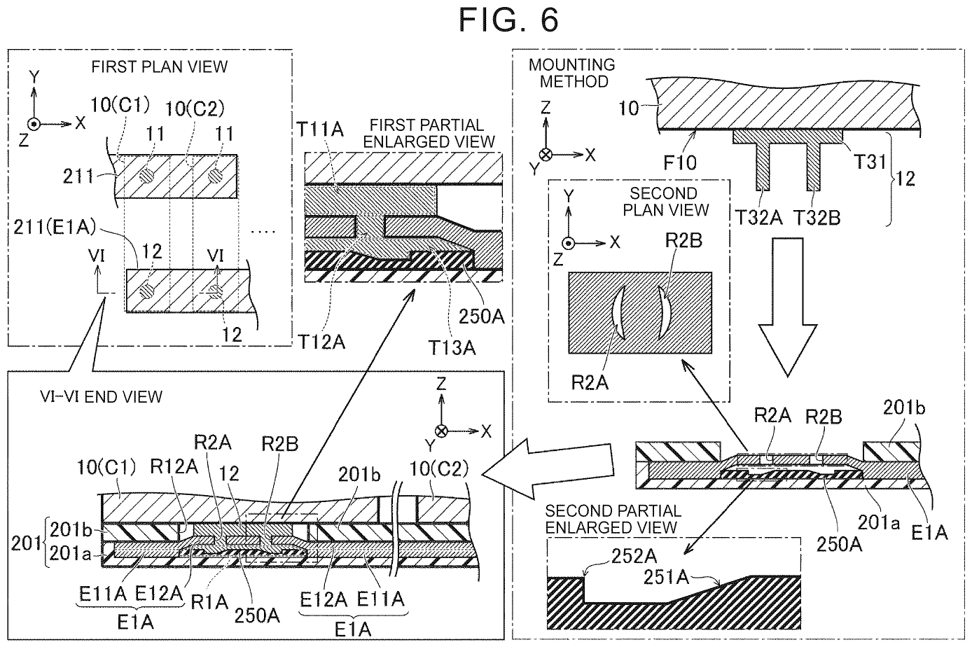

FIG. 6 shows a modification of the configuration shown in FIG. 4. Referring to FIG. 6, a receiving member 250A is disposed in a housing portion R1A formed in a conductor member E1A according to the modification. The conductor member E1A includes a first layer E11A (first conductor layer) located to the side of the receiving member 250A, and a second layer E12A (second conductor layer) connected to the +Z-side end face of the first layer E11A. The second layer E12A has through holes R2A, R2B. More specifically, the insulating sheet 201b has a through hole R12A. The second layer E12A is curved in the +Z-direction (toward the insulating sheet 201b) such that the portion of the second layer E12A in which the through holes R2A, R2B are formed is positioned within the through hole R12A. As shown in the second plan view in FIG. 6, each of the through holes R2A, R2B is formed in an arc shape in the X-Y plane. Each of the through holes R2A, R2B extends from the surface (+Z-side surface) of the conductor member E1A to the housing portion R1A. The housing portion R1A expands outward from each of the through holes R2A, R2B.

Each electrode terminal of the energy storage cell 10 (electrode terminal 12 is illustrated in FIG. 6) includes a first distal end connected to the receiving member 250A through the through hole R2A, and a second distal end connected to the receiving member 250A through the through hole R2B. As shown in the first partial enlarged view in FIG. 6, of these distal ends, the second distal end includes a first portion T11A extending from the body of the energy storage cell 10 to the through hole R2B, a second portion T12A located within the through hole R2B, and a third portion T13A extending from the through hole R2B to the receiving member 250A. The third portion T13A contacts the surface of the receiving member 250A in the housing portion R1A, and is plastically deformed inward (in the −X-direction) and outward (in the +X-direction) on the surface of the receiving member 250A. The first distal end has the same structure as the second distal end. However, in the first distal end, the +X-direction corresponds to inward, and the −X-direction corresponds to outward.

As shown in the second partial enlarged view in FIG. 6, the surface of the receiving member 250A includes an inclined surface 251A that slopes downward toward the outside, and a step 252A located outward of the inclined surface 251A. The second partial enlarged view shows only the configuration of the receiving member 250A on the through hole R2A side. However, the receiving member 250A has a configuration that is symmetrical with respect to the Y-Z plane. Each of the through holes R2A, R2B is located above (on the +Z-side of) the inclined surface 251A. The receiving member 250A is made of, for example, a metal. However, the receiving member 250A may be made of an insulating material.

Before the energy storage cell 10 is mounted, each electrode terminal (electrode terminal 12 is illustrated in FIG. 6) includes a disc-shaped proximal end T31 connected to the body (surface F10) of the energy storage cell 10, and two distal ends T32A, T32B protruding in the −Z-direction from the proximal end T31. The distal ends T32A, T32B have shapes that allow them to be inserted into the through holes R2A, R2B, respectively. Each of the distal ends T32A, T32B may be formed in a plate shape curved to match the planar shape of a corresponding one of the through holes R2A, R2B. During the mounting of the energy storage cell 10, the distal ends T32A, T32B are respectively inserted into the through holes R2A, R2B, and each of the distal ends T32A, T32B is pressed against the inclined surface 251A and is thus plastically deformed. As the distal ends T32A, T32B are thus plastically deformed outward and come into contact with the step 252A, the distal ends T32A, T32B are further plastically deformed in the +Z-direction (toward the second layer E12A). The distal ends T32A, T32B thus become the first and second distal ends described above, respectively.

As described above, the configuration shown in FIG. 6 also facilitates connections between the energy storage cells 10 and the conductor members and maintenance of the connections. The various features of the energy storage device described above (the features described in the embodiment and the modification) may be applied in any combination. Furthermore, some components may be omitted as appropriate. For example, the insulating sheet 201b may be omitted. The energy storage device may be used for any purpose. The energy storage device may be used in vehicles other than automobiles, mobile machines (such as agricultural machines and construction machines), unmanned moving objects, robots, or buildings.

The embodiment disclosed herein should be considered to be illustrative in all respects and not restrictive. The scope of the present disclosure is set forth in the claims rather than in the above description of the embodiment, and is intended to include all modifications within the meaning and scope equivalent to the claims.

What is claimed is:

1. An energy storage device including an energy storage cell including an electrode terminal, and a conductor member, wherein:
the conductor member includes a housing portion and a first through hole extending from a surface of the conductor member to the housing portion;
the energy storage device further includes a receiving member disposed in the housing portion; and
the electrode terminal is connected to the receiving member through the first through hole, and is electrically connected to the conductor member at a position outward of the first through hole in the housing portion.

2. The energy storage device according to claim 1, wherein:
the electrode terminal includes
a first portion extending from a body of the energy storage cell to the first through hole,
a second portion located within the first through hole, and
a third portion extending from the first through hole to the receiving member; and
the third portion contacts a surface of the receiving member in the housing portion and is plastically deformed outward on the surface of the receiving member.

3. The energy storage device according to claim 2, wherein the surface of the receiving member includes an inclined surface that slopes downward toward outside, and a step located outward of the inclined surface.

4. The energy storage device according to claim 1, further comprising:
an upper cover;
a lower case;
a shear panel; and
a wiring board, wherein:
the energy storage cell and the wiring board are housed between the lower case and the upper cover;
the wiring board includes a wiring pattern provided by a plurality of conductor members including the conductor member;
the energy storage cell includes the electrode terminal and an exhaust valve on a surface facing downward in a vertical direction; and
an exhaust passage is provided between the lower case and the shear panel.

5. The energy storage device according to claim 4, wherein:
the wiring board further includes a first insulating layer and a second insulating layer;
the first insulating layer has a recess;
the conductor member and the receiving member are disposed in the recess;
the conductor member includes a first conductor layer located to a side of the receiving member and a second conductor layer having the first through hole; and
the second insulating layer has a second through hole at a position corresponding to the first through hole, and covers the first insulating layer and the second conductor layer.
